(19) United States
(12) Patent Application Publication
(10) Pub. No.: US 2015/0141095 A1
(43) Pub. Date: May 21, 2015

(54) FLIP TYPE CASE FOR PORTABLE ELECTRONIC DEVICE

(71) Applicant: SAMYANG CNS CO., LTD., Bucheon-si (KR)

(72) Inventor: Sung Jun KIM, Seoul (KR)

(73) Assignee: SAMYANG CNS CO., LTD., Bucheon-si (KR)

(21) Appl. No.: 14/536,822

(22) Filed: Nov. 10, 2014

(30) Foreign Application Priority Data
Nov. 19, 2013 (KR) 20-2013-0009512

(51) Int. Cl. H04B 1/3888; H04M 1/02

(52) U.S. Cl. CPC H04B 1/3888; H04M 1/0202
USPC 455/575.8

(57) ABSTRACT

A flip-type protection case for portable electronic device of the present invention has a flexibility and thus provides improved grip feeling, and end portions of the protection case do not cause soreness to a hand and thus the protection case is convenient is to be used. The flip-type protection case for portable electronic device of the present invention includes a rear cover part (100) covering a rear face of the portable electronic device; and a front cover part (300) connected to the rear cover part (100) by a connection part (200) and covering a front face of the portable electronic device, wherein a core material (430) is embedded between a pair of skins (410, 420) at least in the front cover part (300) of the rear cover part (100) and the front cover part (300), and wherein the core material (430) is a sheet formed of rubber or thermoplastic elastomer.

### TECHNICAL FIELD

The invention relates to a flip-type protection case for portable electronic device, and more particularly, to a flip-type protection case for portable electronic device having a novel configuration wherein a grip feeling is improved and thus the protection case is convenient to use.

### BACKGROUND ART

Use of various mobile electronic devices such as cellular phone, tablet PC etc. is prevalent, and the mobile electronic devices are commonly used while being covered by a separate protection case for protecting the mobile electronic devices from a shock to prevent occurrence of scratch on a surface thereof.

FIG. 1 shows that the cellar phone is covered by a flip-type protection case. As illustrated in the figure, the flip-type protection case consists of a flip for covering a front face of the cellar phone, i.e., a front cover part (10), and a connection part (20) extending from one side of the front cover part (10) and releasably coupled with a battery cover (4) of the cellular phone (2).

As illustrated in FIG. 2, such a protection case is formed by a pair of leather skins (31, 32) laminated one above the other and a core material (33) is embedded between the skins (31, 32) in the front cover part (10).

The core material (33) is intended to add a weight to the front cover part (10) to enable the front cover part (10) to effectively cover the front face of the cellar phone (2). For such a core material (33), somewhat hard material such as metal plate, plastic plate, paper board etc. is mainly used.

Meanwhile, when the cellular phone is used while being covered by the protection case, the front cover part (10) is opened and folded over a rear face of the cellular phone (2) as illustrated in FIG. 2. By the way, since the core material (33) is made of the hard material as mentioned above, softness of the skins (31, 33) is lost, which makes the front cover part (10) very hard. Therefore, when the cellular phone is used, an end portion of the front cover part (10) presses user's palm or fingers and thus the hand is sore, which makes the use of the protection case inconvenient.

In general, a perimeter portion of the rear face of most of the electronic devices including the smart phone is curved for the electronic devices to be convenient to be held and used by hand; however, since the front cover part (10) of the protection case is hard as mentioned above, the front cover part cannot be bent corresponding to the perimeter portion of the rear face of electronic devices. Therefore, in a case where the use of electronic devices are used for a long time, the end portion of the front cover part (10) presses the hand to cause a pain.

### DOCUMENT OF RELATED ART

Korean Laid-Open Patent No. 10-2013-0074740(2013. 07. 04).

### SUMMARY OF THE INVENTION

### Technical Problems

The present invention was made in order to solve the above-mentioned problems, and its object is to provide a flip-type protection case for portable electronic device having a novel configuration wherein the protection case is provided with flexibility, thereby exhibiting an improved grip feeling and accordingly an end portion of the protection case does not cause soreness to a hand and so the protection case is convenient to be used.

### Solution to the Problem

According to a feature of the present invention, a flip-type protection case for portable electronic device is provided, which case includes a rear cover part (100) covering a rear face of the portable electronic device; and a front cover part (300) connected to the rear cover part (100) by a connection part (200) and covering a front face of the portable electronic device, wherein a core material (430) is embedded between a pair of skins (410, 420) at least in the front cover part (300) of the rear cover part (100) and the front cover part (300), and wherein the core material (430) is a sheet formed of rubber or thermoplastic elastomer.

According to another feature of the present invention, opening portions (412, 422) are formed in the skins (410, 420) which form the front cover part (300), the core material (430) is double injection molded on a perimeter portion of a see-through window member (450) formed of transparent hard synthetic resin with a size corresponding to the opening portions (412, 422),and when the core material (430) is embedded in the front cover part (300), the see-through window member (450) is exposed to the outside through the opening portions (412, 422) and thus a see-through window (320) is formed for externally viewing a crystal screen of the portable electronic device.

According to yet another feature of the present invention, opening portions (412, 422) are formed in the skins (410, 420) which form the front cover part (300), the core material (430) is formed of transparent thermoplastic elastomer, and the core material (430) is exposed to the outside through the opening portions (412, 422) and thus a see-through window (320) is formed for externally viewing a crystal screen of the portable electronic device.

According to yet another feature of the present invention, the transparent thermoplastic elastomer consists of polybutylene adipate with number-average molecular weight of 600 to 2500 and 7 to 66 parts by weight with respect to total 100 parts by weight, polyhexylene adipate with number-average molecular weight of 600 to 2500 and 3 to 20 parts by weight, 1,2-ethylene glycol with 3 to 29 parts by weight, 1,4-butanediol with 1 to 6 parts by weight, 1,6-hexamethylene diisocyanate with 7 to 46 parts by weight, and 4,4′-methylene diphenyl diisocyanate with 3 to 14 parts by weight.

According to yet another feature of the present invention, the rear cover part (100) consists of a battery cover of the portable electronic device.

### Effects of the Invention

According to the present invention having the above-described configuration, since the core material (430) of the protection case is formed of the rubber or thermoplastic elastomer and thus has the elasticity and flexibility, the rear cover part (100) and front cover part (300) with the core embedded therein has the elasticity and flexibility. Therefore, when using the portable electronic device, the rear cover part (100) and the front cover part (300) are smoothly curved by a force applied by the hand, and thus end portions of the two cover parts do not cause soreness to the hand and a good grip feeling is provided.

In particular, when the see-through window (320) is to be formed in the front cover part (300), the core material (430) is formed of the transparent thermoplastic elastomer and the opening portions (412, 422) are formed in the skins (410, 420), and thus the opening portions (412, 422) are covered by the core material (430) to form the see-through window (320). Therefore, a separate transparent member for forming the see-through window (320) does not have to be formed, which is economical and results in easy production.

In addition, the see-through window member (450) may be formed with a size corresponding to the opening portions (412, 422) by the use of the transparent hard synthetic resin, and the core material (430) may be double injection molded on the perimeter portion of the see-through window member (450) to form the see-through window (320) by the see-through window member (450). In this case, producing is cumbersome compared to a case where the core material (430) is formed of the transparent elastomer; however, an advantage is provided that the transparency of the see-through window (320) can be increased by using synthetic resin with a high transparency for the see-through window member (450).

### BRIEF DESCRIPTION OF THE DRAWINGS

FIG. 1 is an exploded perspective view illustrating a prior protection case;

FIG. 2 is a cross-sectional view illustrating a used state of FIG. 1;

FIG. 3 is a perspective view illustrating a first embodiment of the present invention;

FIG. 4 is a cross-sectional view illustrating a used state of the first embodiment;

FIG. 5 is a perspective view illustrating a second embodiment of the present invention;

FIG. 6 is a cross-sectional view taken along line A-A in FIG. 5;

FIG. 7 is a cross-sectional view illustrating a third embodiment of the present invention; and

FIG. 8 is an exploded perspective view illustrating a fourth embodiment of the present invention.

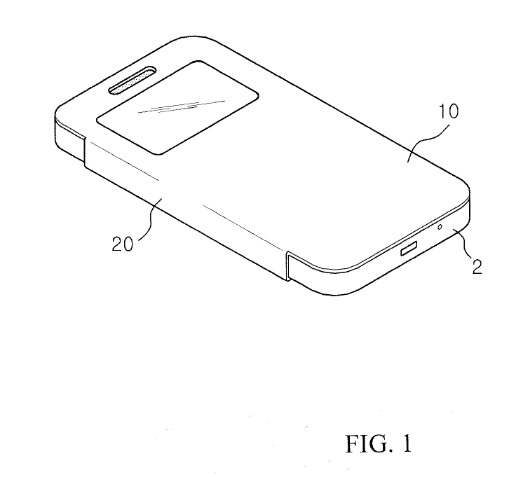

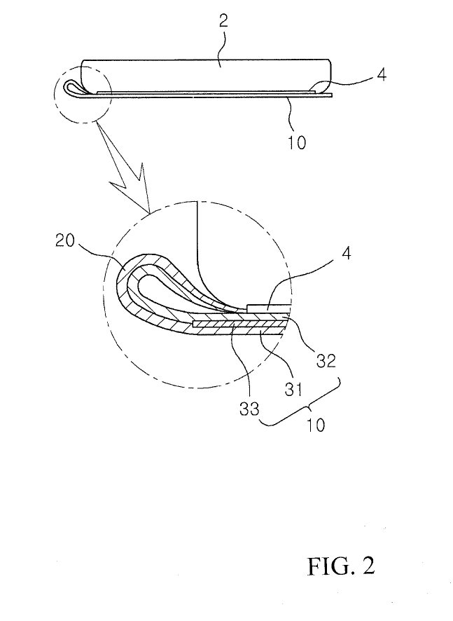

### BEST MODES FOR CARRYING OUT THE INVENTION

Hereinafter, the present invention will be described in detail with reference to the drawings. Application of the present invention to a protection case for smart phone will be described by way of example.

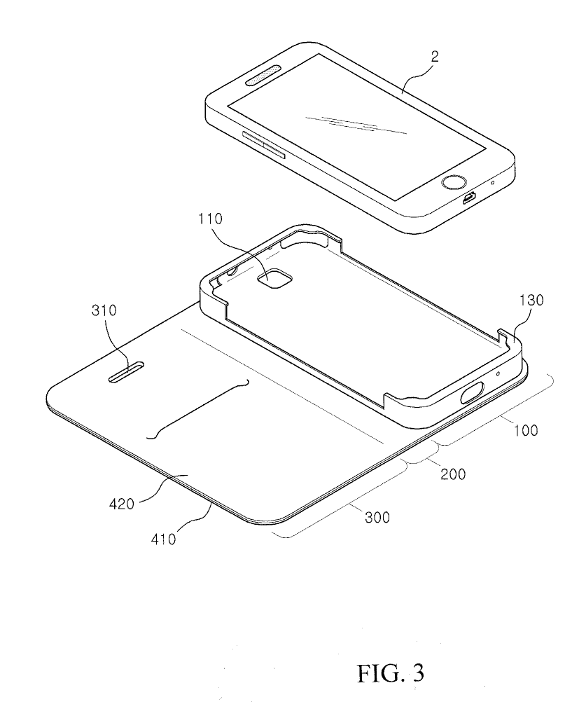

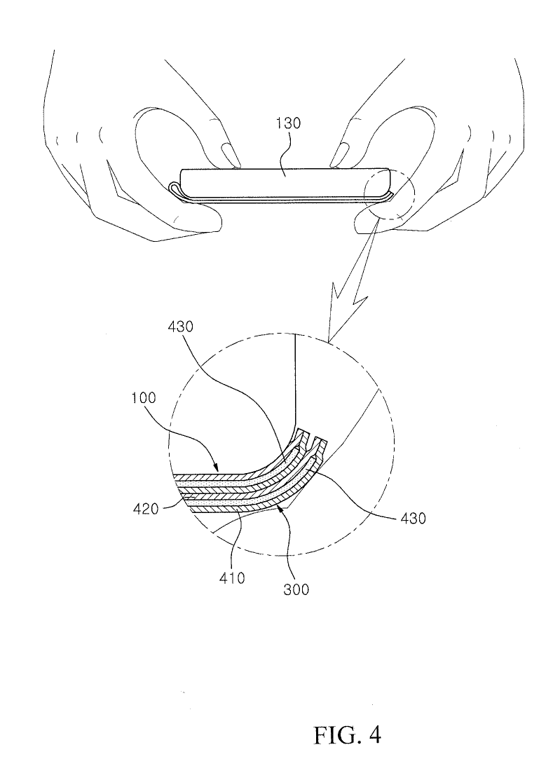

FIGS. 3 and 4 are perspective view illustrating a first embodiment of the present invention, and cross-sectional view illustrating a used state thereof, respectively. As illustrated, the present invention includes a rear cover part (100) covering a rear face of a smart phone (2); and a front cover part (300) connected to one side of the rear cover part (100) by a connection part (200) and covering a front face of the smart phone (2).

These rear cover part (100), connection part (200) and front cover part (300) are formed by a pair of skins (410, 420) laminated one above the other, wherein the skins (410, 420) consist of natural leather or synthetic leather. Thus, the rear cover part (100), connection part (200) and front cover part (300) have flexibility.

Meanwhile, a core material (430) is embedded in the rear cover part (100) and the front cover part (300). The core material (430) is formed of rubber or thermoplastic elastomer and is preferably extruded as a sheet having a thickness of about 0.8˜1 mm.

Since the core material (430) is formed of the rubber or thermoplastic elastomer and thus has elasticity and flexibility, the flexibility of the rear cover part (100) and front cover part (300) is not lost even though the core material (430) is embedded. Preferably, the core material (430) does not have to be vulcanized and is formed of the thermoplastic elastomer that can be easily extruded.

The present invention having such a configuration is produced by cutting the skins (410, 420) such that rear cover part (100), connection part (200) and front cover part (300) are connected in one piece, disposing the core material (430) in the rear cover part (100) and the front cover part (300) and performing attaching by hotmelt adhesive.

Of course, in order that the skins (410, 420) are attached to each other at perimeter portions of the rear cover part (100) and front cover part (300), the core member (430) is formed with a somewhat smaller size than the rear cover part (100) and front cover part (300). Furthermore, of course, through-holes (110, 310) are formed so as to expose a camera lens, a speaker and also buttons of the smart phone (2). A reference numeral “130” not described designates a holder which is attached to the rear cover part (100) and on which the smart phone is mounted.

In the present invention having such a configuration, since the core material (430) is formed of the rubber or thermoplastic elastomer and thus has the elasticity and flexibility, the rear cover part (100) and front cover part (300) also have flexibility due to the core material (430).

Therefore, in a case of using of the smart phone (2), when the front cover part (300) is folded so as to overlapped over the rear cover part (100) and then held by the hand as illustrated in FIG. 4, end portions of the front cover part (300) and the rear cover part (100) are smoothly curved by a force applied by the hand, and thus an inconvenience is avoided that the rear cover part (100) or the front cover part (300) causes soreness to the palm or fingers and a good grip feeling is provided.

In the following, another embodiment of the present invention will be described. Description of the same configuration and effect as the previous embodiment will be omitted.

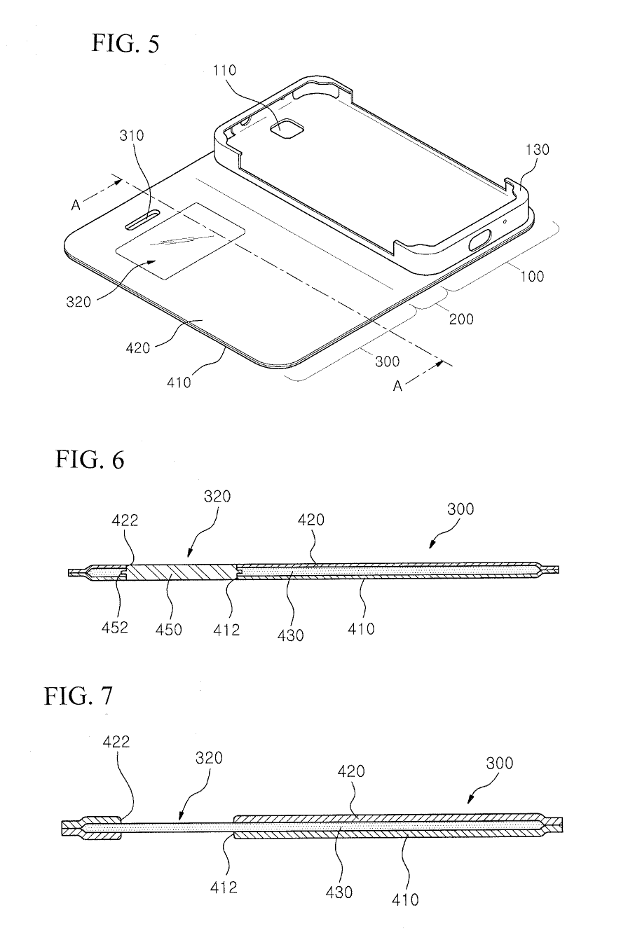

FIGS. 5 and 6 shows a second embodiment of the present invention, wherein a see-through window (320) for viewing a crystal screen of the smart phone is formed in the front cover part (300).

In the second embodiment, opening portions (412, 422) are formed in the skins (410, 412) which form the front cover part (300), and a see-through window member (450) is further provided for covering the opening portions (412, 422). The see-through window member (450) is made of transparent hard synthetic resin sheet such as PC; as illustrated in FIG. 6, the see-through window member (450) is formed with a size corresponding to the opening portions (412, 422), and the core material (430) is double injection molded on a perimeter portion of the see-through window member (450).

Preferably, as illustrated, protrusions (452) are formed on the perimeter portion of the see-through window member (450). These protrusions (452) enhances a strength of coupling between the core material (430) and the see-through window member (450).

In such a case where a portion of the core material (430) is formed by the separate see-through window member (450), the see-through window member (450) of the core material (430) may be shaped of synthetic resin having an excellent transparency; therefore, an advantage is provided that the see-through window (320) having a high transparency can be formed.

FIGS. 7 shows a third embodiment of the present invention, wherein, unlike the previous embodiment, the separate see-through window member (450) is not used and the see-through window (320) is formed by the core material (430).

In the third embodiment, the core material (430) is formed of transparent thermoplastic elastomer and the core material (430) is exposed to the outside through the opening portions (412, 422) of the skins (410, 420), thereby forming the see-through window (320). Since the see-through window (320) is formed by the core material (430) like this, it is preferred that the core material (430) is formed of thermoplastic elastomer having a high transparency.

For this purpose, in the third embodiment, the core material (430) is formed by extruding thermoplastic elastomer consisting of polybutylene adipate with number-average molecular weight of 600 to 2500, polyhexylene adipate with number-average molecular weight of 600 to 2500, 1,2-ethylene glycol, 1,4-butanediol, 1,6-hexamethylene diisocyanate, and 4,4′-methylene diphenyl diisocyanate. If the number-average molecular weight of the polybutylene adipate and polyhexylene adipate is less than 600, cooling and solidification time after the extrusion of the core material (430) is extended and thus the productivity decrease, and if the number-average molecular weight is greater than 2500, these polyols themselves have a high crystallinity and thus it is difficult to ensure the transparency of the core material (430). These polybutylene adipate and polyhexylene adipate are contained with 7 to 66 parts by weight and 3 to 20 parts by weight, respectively with respect to total 100 parts by weight of the thermoplastic elastomer.

If these polybutylene adipate and polyhexylene adipate are each contained below the above indicated level, the elasticity and flexibility of the core material (430) decrease, and if they are each contained above the level, reaction rate is slowed down and thus formation of polymers becomes difficult, which is not preferable. Furthermore, when the polybutylene adipate and polyhexylene adipate are each contained with the above indicated level, a best transparency can be obtained.

In addition, the 1,2-ethylene glycol and 1,4-butanediol are contained with 3 to 29 parts by weight and 1 to 6 parts by weight, respectively with respect to total 100 parts by weight of the thermoplastic elastomer. If the 1,2-ethylene glycol and 1,4-butanediol are contained below the above indicated level, the molecular weight of the polymers does not increase and thus preferred properties cannot be obtained. If they are each contained above the level, the elasticity and flexibility of the core material (430) decrease and the cooling and solidification time is extended in the extrusion of the core material (430), which is not preferable.

The 1,6-hexamethylene diisocyanate and 4,4′-methylene diphenyl diisocyanate are contained with 7 to 46 parts by weight and 3 to 14 parts by weight, respectively with respect to total 100 parts by weight of the thermoplastic elastomer. If the 1,6-hexamethylene diisocyanate and 4,4′-methylene diphenyl diisocyanate are each contained below the above indicated level, reactivity decreases and thus polymerization reaction does not properly occur. If they are each contained above the level, soft segments and hard segments of the elastomer undergo phase separation and thus the elasticity and flexibility of the core material (430) decrease and mechanical properties also decrease.

The core material (430) formed of the thermoplastic elastomer having such a composition has an excellent transparency of 88 or more (as measured according to ASTM D1033) and a curvature deformation rate of 20% or less and thus is excellent in elasticity, i.e., flexibility.

When the core material (430) is formed of the transparent thermoplastic elastomer like this, the opening portions (412, 422) of the skins (410, 420) are covered by the core material (430) to form the see-through window (320), whereby an advantage is provided that a separate see-through window member does not have to be used for forming the see-through window (320).

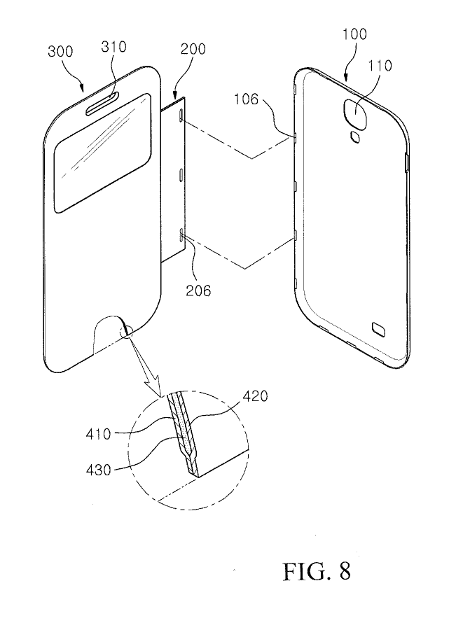

FIG. 8 shows a fourth embodiment of the present invention, wherein the rear cover part (100) consists of a battery cover of the smart phone.

In this case, the front cover part (300) and the connection part (200) are integrally formed by the skins (410, 420), and the core material (430) is embedded only in the front cover part (300).

Meanwhile, the rear cover part (100) is injection molded of plastic and has coupling protrusions (106) formed on a perimeter portion of its rear face for releasable coupling with the smart phone (2). Then, on an end portion of the connection part (200), insertion holes (206) are formed into which the coupling protrusions (106) are inserted.

Therefore, the connection part (200) is connected to the rear face of the smart phone (2) by the rear cover part (100).

When the rear cover part (100) is formed by the battery cover of the smart phone (2) like this, the battery cover does not have to be separately formed, which is economical, and the volume is reduced compared to a case where the smart phone is covered by a protection case consisting of the rear cover part, connection part and front cover part in the presence of the battery cover, whereby an advantage is provided that the smart phone looks slim.

### DESCRIPTION OF REFERENCE NUMERALS

2: smart phone
100: rear cover part
106: insertion protrusion
110, 310: through-hole
130: holder
200: connection part
206: insertion hole
300: front cover part
320: see-through window
410, 420: skin
412, 422: opening portion
430: core material
450: see-through window member
452: protrusion

1. A flip-type protection case for portable electronic device, comprising:
a rear cover part (100) covering a rear face of the portable electronic device; and
a front cover part (300) connected to the rear cover part (100) by a connection part (200) and covering a front face of the portable electronic device,
wherein a core material (430) is embedded between a pair of skins (410, 420) at least in the front cover part (300) of the rear cover part (100) and the front cover part (300), and
wherein the core material (430) is a sheet formed of rubber or thermoplastic elastomer.

2. The flip-type protection case for portable electronic device according to claim 1, wherein opening portions (412, 422) are formed in the skins (410, 420) which form the front cover part (300),
the core material (430) is double injection molded on a perimeter portion of a see-through window member (450) formed of transparent hard synthetic resin with a size corresponding to the opening portions (412, 422),and
when the core material (430) is embedded in the front cover part (300), the see-through window member (450) is exposed to the outside through the opening portions (412, 422) and thus a see-through window (320) is formed for externally viewing a crystal screen of the portable electronic device.

3. The flip-type protection case for portable electronic device according to claim 1, wherein opening portions (412, 422) are formed in the skins (410, 420) which form the front cover part (300),
the core material (430) is formed of transparent thermoplastic elastomer, and
the core material (430) is exposed to the outside through the opening portions (412, 422) and thus a see-through window (320) is formed for externally viewing a crystal screen of the portable electronic device.

4. The flip-type protection case for portable electronic device according to claim 3, wherein the transparent thermoplastic elastomer consists of polybutylene adipate with number-average molecular weight of 600 to 2500 and 7 to 66 parts by weight with respect to total 100 parts by weight, polyhexylene adipate with number-average molecular weight of 600 to 2500 and 3 to 20 parts by weight, 1,2-ethylene glycol with 3 to 29 parts by weight, 1,4-butanediol with 1 to 6 parts by weight, 1,6-hexamethylene diisocyanate with 7 to 46 parts by weight, and 4,4′-methylene diphenyl diisocyanate with 3 to 14 parts by weight.

5. The flip-type protection case for portable electronic device according to claim 1, wherein the rear cover part (100) is a battery cover of the portable electronic device.
